(19) United States
(12) Patent Application Publication
(10) Pub. No.: US 2004/0012595 A1
(43) Pub. Date: Jan. 22, 2004

(54) Electronic manual

(76) Inventor: Brian R. Tarasi, Edgeworth, PA (US)

Correspondence Address: Daniel J. Long, 18 Rhodora Drive, Amherst, NH, 03031, US

(21) Appl. No.: 10/198,802

(22) Filed: Jul. 19, 2002

(51) Int. Cl. G06T 1/00

(52) U.S. Cl. 345/501

(57) ABSTRACT

A portable hand held reading unit comprising a housing, a display screen mounted on said housing for displaying data thereon, memory means for storing data as computer usable code, and means for downloading revisions to the data stored in the memory means.

### CROSS REFERENCE TO RELATED APPLICATIONS

This application claims rights under applicant's U.S. Provisional Application Serial No.______ , filed Jul. 20, 2001.

### BACKGROUND OF THE INVENTION

1. TECHNICAL FIELD

The present invention relates to hand held display devices and more particularly to portable hand held reading devices.

2. BACKGROUND INFORMATION

The prior art discloses various portable hand held reading devices which are commonly known as electronic books. U.S. Pat. No. 4,159,417 to Rubincam, for example, discloses a device in which the contents of a book, magazine or the like are digitally encoded into a memory, and the memory is removably insertable into a portable book-like apparatus whereby the encoded information can be displayed on a screen of the apparatus.

U.S. Pat. No. 5,475,399 to Borsuk discloses a hand held portable reading unit having a screen capable of presenting characters in variable font sizes is provided for readers, such as the visually impaired, allowing them to read characters in a font size most comfortable to them. The reader effects font size changes by depressing font size select button, in turn activating a counter incremented to the umber of times the button has been depressed to generate the corresponding size font desired. The incremented counter may be used to address a particular place in memory where bit-mapped characters of different font sizes are adjusted by a scaling algorithm to generate a desired character font size. The stored textual data may further be presented in useable form to the blind wherein an audible processor is utilized to convert the stored character code into audible signals inputted into a speaker.

U.S. Pat. No. 5,703,624 to van Kruistum discloses a portable image viewer including a compact housing with a cover for protecting a top surface 5 thereof. Also included is a liquid crystal display situated on the top surface of the housing for displaying purposes. A standard floppy disk drive has a receiving aperture for accepting a non-volatile floppy disk and extracting data therefrom. An input port is included for accepting data from a conventional computer. Finally, hardware based control circuitry is situated within the housing 10 and connected to the display and floppy disk drive. The control circuitry, in a first mode, is adapted to retrieve a specific file from the floppy disk and automatically fit the image form the file on the display. In a second mode of operation, the control circuitry is adapted to accept a file via the input port and utilize similar imaging fitting techniques. In both the first mode and second mode of operation, after the image is displayed, the control circuitry is adapted to enlarge the image and pan in multiple directions thereon for viewing more closely different portions thereof.

U.S. Pat. No. 5,774,109 to Winksy, et al. discloses a hand held electronic book machine having a platform with a keyboard and a display for displaying text. The book machine further includes a database mounted to the platform. The database has a first memory portion storing text of a prose work and a second memory portion storing predetermined information relevant to the prose work. The database may be permanently mounted to the platform for enabling the use of the platform with different databases storing tet and ancillary information for different prose works. The book machine also comprises an electronic scrolling mechanism operatively connected to the first memory portion of the database and to the display for scrolling the text on the display. Operator actuated selection componentry is operatively connected to the second memory portion of the database and to the display for permitting operator selection of portions of the predetermined information to be displayed on the display. A delay is operatively connected to the scrolling mechanism and to the operator actuated selection componentry for temporarily interrupting the scrolling, and display, of the text during display of a selected portion of the predetermined information. The predetermined information may include at least one of glossary entries for selected words in the text, summaries of different portions of the text, and resumes of characters in the text.

U.S. Pat. No. 5,956,048 to Gaston discloses an electronic book system including a portable display united and a mated downloading stand which receives the unit in a plug-in manner so that data and power ports of the unit matably connected with respective data and power connectors of the stand. Upon insertion, data is downloaded to a memory in the unit when a data signal is supplied through the data port. The display device has a tabular shaped housing with a display screen and control buttons applied to a front planar surface of the housing. The stand is modularly designed to be stacked adjacently with additional like stands in mated connection with each other for common data and power communication. A system for preventing unauthorized use of stored book data is also provided wherein each unit is assigned a unique electronic code value, and wherein the book data on a particular storage medium may be initially accessed by any coded unit, but wherein subsequent access by other units is denied.

U.S. Pat. No. 6,037,954 to McMahon discloses a easily portable electronic book reading device for reading text information of documents, books, etc. previously stored on a storage medium. The device generally comprises a flat screen monitor, a control panel, and a data storage/reading device. The flat screen monitor displays text information of a document being read, and optionally system control data. The control panel allows the user to control the display of information on the monitor, including selection of a document to be read; moving to a desired page; “book-marking”)a desired page to allow the user to rapidly return to that page at a later time; stepping forward and backward through a document one page at a time; and controlling the size of text displayed on the monitor. The data/reading device, which can conveniently be provided as a CD-ROM or (preferably) a Micro-CD-ROM is provided to read text information from a removable memory medium, for display on the monitor. The flat screen monitor, control panel, and data storage/reading device are housed within a housing designed to facilitate ease and comfort of the user over extended periods of use of the device, and further to effectively protect the various components from damage due to impacts or entry of foreign matter such as dust and sand.

U.S. Pat. No. 6,065,076 to Sorenson discloses a system for tailoring information presented to a user and for tailoring the manner of information selection and presentation, an information station accepts user interchangeable information cards and system cards, the user having selected one information card from a series of system cards for determining the information presented to the user and for determining the manner of information selection and presentation.

At the present, uniformed workers for many corporations and government agencies are required to carry some type of manual either for legal or for company policy reasons.

In, for example, the air transport industry, employee in the flight service departments of airlines are required by both their airlines and the FAA to carry manuals. Typically, such a manual measures 10 in.×9 in., weighs approximately 5 lb., contains over 600 pages of printed material and 21 tabs, and costs over $100.00 to produce. The pages and tabs are held together by a binder type book and the content MUST BE current. This is accomplished by constantly updating the manual as policies and FAA matters change. Pages and tabs must be physically removed and replaced with updated material. The new content comes in stapled bunches called revisions which are anywhere from 10-70 pages in length. The replacement process is very tedious, time consuming, and yields inordinate amounts of waste paper. A typical major airline may produce revisions at roughly 120% to cover all crew members. A typical major airline may employ from 10,000 to 20,000 or more flight attendants.

In view of the above number and the frequency of revision changes, a need exists for an improved means.

### BRIEF SUMMARY OF THE INVENTION

It is an object of the present invention to provide an electronic manual device in which revisions to the text may be easily, quickly, and inexpensively made.

This and other objects are met by the present invention which is an electronic manual in which updated material can be downloaded via the internet or by a suitable inter-company-net. The unit would be cradled into a docking station which is connected to a PC/Mac or a company computer by a USB/docking cradle. The software/hardware used by the main company manual revision center to download manual revisions will utilize existing components streamlined for its particular needs. The electronic manual can be updated immediately before each trip assignment or form the employees' home PC/Mac computer or laptop.

### BRIEF DESCRIPTION OF THE SEVERAL VIEWS OF THE DRAWINGS

The present invention is further described with reference to the accompanying drawings in which:

FIG. 1 is a front elevational view of a hand held display device representing a preferred embodiment of the electronic manual of the present invention;

### DETAILED DESCRIPTION OF THE INVENTION

1. Device

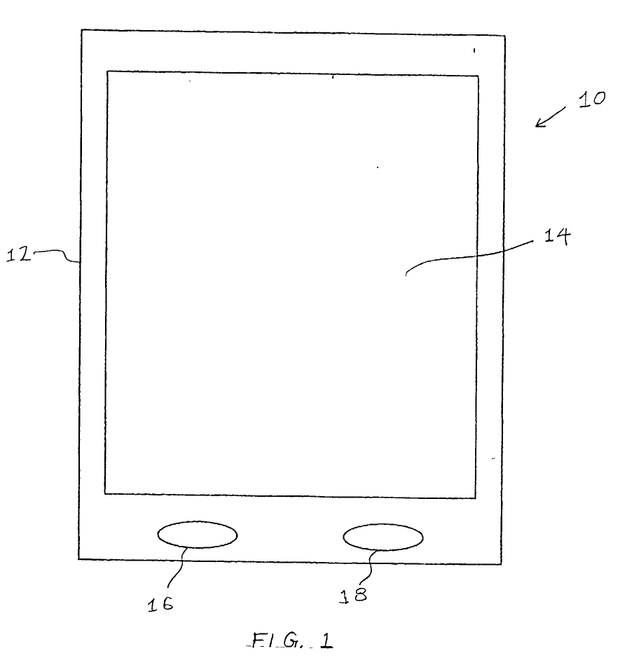

Referring to FIG. 1, the device is shown generally at numeral 10. The device 10 would again measure no larger than 8″×10″×1″. It will be a hard plast casing 12 and offered in a number of colors. The display screen 14 will utilize existing LCD technology and the control buttons 16 and 18 placed on the lower 11/2″ of the front of the unit will number no more than two. The buttons will move pages individually back or forward and the display will be a touch-screen stylus operated type. The OS technology as is commercially available from Palm Corp. Shop, Inc., Windows CE, or Glassbrook, Inc. would be used. The electronic manual is unique since it is a vertically integrated device for a very specific purpose. This approach will keep each units' cost at a minimum.

2. Software

The OS product chosen will depend upon cost and flexibility parameters. Each of the above companies provides extensive software support and development assistance once a licensing agreement has been established. Once selected, the software would be developed to handle the receiving of downloaded pages and e-mail, and the corresponding buttons and stylus interface. This limited amount of software should help keep the cost down and, therefore, make the electronic manual very competitive vis-a-vis other hand held products. The bottom would be designed to slide into a docking cradle and handle downloads from either the company database intranet or from a PC/Mac.

3. Cradle

The docking station will be the ethernet cradle or an internet type connection. The design and link up are fairly standard and stated above connect with either a company intranet or a home based computer system.

4. Synchronization

Finally, the clienUserver link would be handled once again with software from the selected OS once licensing terms are secured. The system would provide for immediate downloading of updated material and e-mail to the user's device via the docking cradle or internet connection link.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

What is claimed is:

1. A portable hand held reading unit comprising:
a housing;
a display screen mounted on said housing for displaying data thereon;
memory means for storing data as computer usable code; and
means for downloading revisions to the data stored in the memory means.
